(19) United States
(12) Patent Application Publication
(10) Pub. No.: US 2016/0314708 A1
(43) Pub. Date: Oct. 27, 2016

(54) Method and System for Converting Text to Speech

(71) Applicant: Freedom Scientific, Inc., St. Petersburg, FL (US)

(72) Inventors: Liad Cohain, Encino, CA (US); Bryce Gochin-Lyon, Chatsworth, CA (US); Yahli Kijel, Sherman Oaks, CA (US); Elijah Aden Rothschild, Newhall, CA (US); Ethan Varnen, West Hills, CA (US); Sally Frances Vogel, Northridge, CA (US)

(21) Appl. No.: 15/134,830

(22) Filed: Apr. 21, 2016

Related U.S. Application Data
(60) Provisional application No. 62/150,742, filed on Apr. 21, 2015.

(51) Int. Cl. G09B 21/00; G08B 6/00; H04N 5/225; G10L 13/08

(52) U.S. Cl. CPC G09B 21/007; G10L 13/08; G08B 6/00; H04N 5/2257

(57) ABSTRACT

Embodiments of the invention relate to devices that can be worn on the body and used to take images of written text and convert that text to an auditory or other signal to aid visually impaired individuals. A method for enabling a user having a visual impairment to understand written text material is provided. The method includes capturing an image containing text or symbols via an image capture module of a first device and communicating the captured image to a second device via a wireless communication medium. The method also includes identifying the text or symbols within the captured image via an image processing module of the second device and converting, via an audio conversion module of the second device, the identified text to audio for playback. The method further includes playing the audio received from the second device for the user.

### CROSS REFERENCE TO RELATED APPLICATION

This application claims benefit of co-pending provisional patent application Ser. No. 62/150,742 filed on Apr. 21, 2015 and entitled “Method and System for Converting Text to Speech.” The contents of this co-pending application are fully incorporated herein for all purposes.

### TECHNICAL FIELD

The described technology generally relates to systems and methods that allow people having visual impairments to understand a variety of written text material. More specifically, the disclosure is directed to devices, systems, and methods related to communicating written, typed, or displayed text audibly, haptically, or via any other non-visual means for the benefit of people who have difficulty reading or are unable to read the text themselves due to a visual impairment.

### BACKGROUND

In everyday life, people are confronted with dozens of items containing text or other written symbols, such as newspapers, flyers, manuals, books and the like. This text may communicate messages or other important information. However, people who are visually impaired may have difficulty reading these items. Various devices exist to help people read or otherwise gain access to text or symbols, such as glasses, magnifying glasses, alternative technology (low and/or high tech technology), or other augmentative and alternative communication (AAC) devices and aids. These devices may provide users with the ability to view and otherwise obtain the information contained in the text and written symbols. However, these devices may be difficult to use or difficult to transport, or may not be able to assist people with complete visual impairment.

For example, a person with total blindness may not gain any benefit from a pair of glasses, or from a magnifying glass, as the magnified images could still not be seen. A computer configured to scan a document and convert the scanned text to speech (audio) may be difficult or impossible to transport and use in a mobile setting. Additionally, some of these devices may be unable to handle text of specific formats or may require a user of the devices to follow the text being communicated line by line and character by character. Accordingly, there is a need for portable, easy to use, and versatile assistive devices capable of allowing a user to read text and symbols on a variety of mediums that are available to the user.

### SUMMARY

The implementations disclosed herein each have several innovative aspects, no single one of which is solely responsible for the desirable attributes of the invention. Without limiting the scope, as expressed by the claims that follow, the more prominent features will be briefly disclosed here. After considering this discussion, one will understand how the features of the various implementations provide several advantages over current wireless charging systems.

A system for enabling a user having a visual impairment to understand written text material is provided. The system includes a first device configured to capture at least one image containing text or symbols. The first device contains an image capture module configured to capture the at least one image, store the at least one image, and communicate the at least one image. The first device also contains, a memory configured to store the at least one image, and a transceiver configured to transmit the at least one image. The first device also includes a vibrating device configured to provide haptic feedback and one or more controls configured to allow the user to interact with the first device. The system further includes a second device configured to receive the at least one image from the first device and convert the text or symbols in the at least one image to audio for playback. The second device includes a transceiver configured to receive the captured image from the first device, an audio device configured to play an audio file, an image processing module configured to identify text in the at least one image, an audio conversion module configured to convert the identified text to audio and save the audio in the audio file, and an audio playback module configured to play the audio file for the user via the audio device. The second device also includes a memory configured to store the at least one image and the audio file.

A method for enabling a user having a visual impairment to understand written text material is provided. The method includes capturing an image containing text or symbols via an image capture module of a first device and communicating the captured image to a second device via a wireless communication medium. The method also includes identifying the text or symbols within the captured image via an image processing module of the second device and converting, via an audio conversion module of the second device, the identified text to audio for playback. The method further includes playing the audio received from the second device for the user.

### BRIEF DESCRIPTION OF THE DRAWINGS

The above-mentioned aspects, as well as other features, aspects, and advantages of the present technology will now be described in connection with various implementations, with reference to the accompanying drawings. The illustrated implementations, however, are merely examples and are not intended to be limiting. Throughout the drawings, similar symbols typically identify similar components, unless context dictates otherwise. Note that the relative dimensions of the following figures may not be drawn to scale.

FIG. 1 is a schematic diagram of a system comprising one or more devices configured to convert text or other written symbols into audio signals to allow a user with a visual impairment to understand the text or other symbols, in accordance with an exemplary implementation.

FIG. 2 is a schematic diagram of the system comprising a ring and a computer, configured to convert observed text or symbols to audio, in accordance with an exemplary implementation.

FIG. 3 shows an exemplary functional block diagram of a processing system for observing and capturing text and providing audio playback of the captured text, the processing system comprising a mobile device (MD) configured to communicate with a processing device (PD), both as referenced in FIGS. 1 and 2.

FIG. 4 shows a schematic of an embodiment of the MD as the ring as it may be placed on the user's hand or finger, in accordance with an exemplary implementation.

FIG. 5 is a flowchart depicting a method for observing text and/or symbols and converting them to audio for playback to a user, in accordance with an exemplary implementation.

### DETAILED DESCRIPTION

Embodiments of the invention relate to devices that can be worn on the body and used to take images of written text and convert that text to an auditory or other signal to aid visually impaired individuals. In one example, the device is configured as a ring-shaped housing that mounts on a user's finger, or over several fingers, and includes a digital camera. Because the device is designed to be used by visually impaired individuals, it may contain features allowing the device to be operated by haptic or auditory cues. For example, the device may be operated by pointing the digital camera at a sheet of paper. Because the user may not know how to properly align the camera, the device may vibrate to provide haptic feedback, or emit an auditory signal, when a properly focused image of the paper has been captured. After capture, the captured image can be processed locally, or transmitted to a nearby portable device, such as a smart phone, for processing. One or more software applications running on the portable device can perform optical character recognition (OCR) on the scanned image to convert the image into text data. The software application can then send the text to a text-to-speech synthesizer which will read the text aloud from the portable device. This device can thereby allow a visually impaired person to understand the content written on the paper.

One aspect is that the device is programmed to understand a variety of types of documents. For example, the device may include software for first determining what type of document has been captured. The document may be determined to be an outline, a manual of instructions, a menu, a book page (or pages), a spreadsheet, or other well know text format. By determining the type of document, the device can then determine how to properly output that information to the user in a spoken manner that is most easily perceived by the user. For example, a menu may be output as short sentences with a break between. A book may be continuously output. The device may also be programmed to receive input from the user on how to output the text. The device may be programmed to detect motion, such as a user tapping the ring, to stop or start auditory playback. Other indications, such as multiple taps on the device may be used to control skipping, or changing the speed of playback. It should be realized that these controls may also be integrated into the application running on the portable device.

Of course, the device is not limited to one that is shaped as a ring. Other embodiments, such as glasses, bracelets, hats, or any other device configured as described herein may be within the scope of embodiments of the invention.

One aspect of the device is an end-to-end solution for allowing a user to autonomously use the described system in conjunction with everyday functions. For example, the user may have a cell phone running an associated application in the user's pocket with a Bluetooth headset in the user's ear and the ring including the digital camera on a finger. The user may walk up to a sign or a map or receive an item, and use the ring to capture an image of the sign, map, or item. The app operating on the cell phone may automatically detect that the ring was used to capture the image and may begin analyzing the image to identify any text therein. The cell phone may then convert any captured text to audio, and transmit the audio to the Bluetooth headset such that the user can hear the text identified on the sign, map, or item.

In the following detailed description, reference is made to the accompanying drawings, which form a part of the present disclosure. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and form part of this disclosure.

The terminology used herein is for the purpose of describing particular implementations only and is not intended to be limiting of the disclosure. It will be understood by those within the art that if a specific number of a claim element is intended, such intent will be explicitly recited in the claim, and in the absence of such recitation, no such intent is present. For example, as used herein, the singular forms “a”, “an” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and “including,” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

People having visual impairments often are at a disadvantage when living in the present world. While in their private lives or communities, people with visual impairments may learn to communicate via written methods that can be understood without use of one's eyes, for example Braille. However, in general public interactions and commercial settings, people with visual impairments may be at a disadvantage in communicating with other people via text or written documents. Specifically, the people with visual impairments may be at a disadvantage with regards to reading text on documents or items presented to them. For example, at many restaurants, menus and lists of ingredients may not be available in Braille or some other format for communication to someone with a visual impairment. Alternatively, or additionally, handouts at presentations, materials received in the mail, or manuals and receipts of purchased products may be provided as printed documents only, and thus may not communicate to the recipient the information disclosed therein.

The systems and devices described below allow users to read written documents without requiring that writing on the various items be converted to Braille or a similar writing system. These systems and devices may allow the users to be more active in society by making accessible to them many items having written text on them that would otherwise be difficult for the users to read and understand.

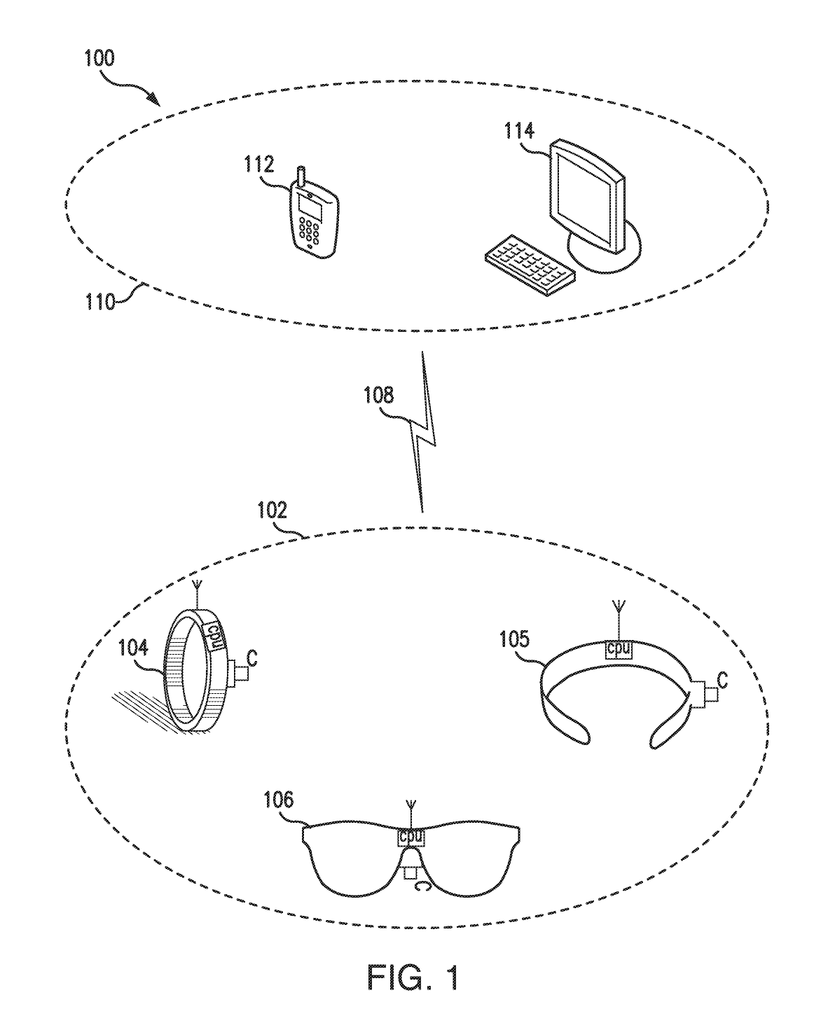

FIG. 1 is a schematic diagram of a system 100 comprising one or more devices that may convert text or other symbols to audio to allow a user with a visual impairment to understand the text or other symbols, in accordance with an exemplary implementation. The system 100 depicts two groups of devices, mobile devices 102 and processing devices 110. The group of mobile devices 102 includes devices that may allow the user to capture images of items comprising text, for example a piece of paper or a menu. The group of processing devices 110 includes devices that may be used to process the images captured by the mobile devices 102 and convert the text of the captured images to audio to be played for the user, thus communicating, to the user, the text or other symbols in a manner understandable by the user, such as through auditory signals.

In some embodiments, the group of the mobile devices 102 may include a ring 104, a head band 105, and a pair of glasses 106. The various devices of the group of mobile devices 102 may each include a camera (C), a controller (CPU), an antenna of a transceiver, and various other components (described in more detail below, but not all shown in this figure). The group of mobile devices 102 are shown as being in communication with the group of processing devices 110 via communication path 108. The group of processing devices 110 include a cellular phone 112 and computer 114. As described herein, the system 100 may utilize one or more devices from each of the group of mobile devices 102 and the group of processing device 110 to facilitate the communication of text and symbols to a person using the system 100.

In operation, one of the devices of the group of mobile devices 102 may be configured to capture an image comprising one or more words of text or other symbols that the user would like to “read.” For example, the camera (C) in the ring 104 is able to capture an image of the desired text or other symbols for the user. The ring 104 may then communicate the captured image to one of the devices of the group of processing devices 110 via the communication path 108.

For example, the user may have a cellular phone 112 that can receive the captured image from the ring 104 via the communication path 108. The cellular phone 112 may be configured with an OCR program to analyze the captured image and identify the text and symbols contained within the captured image. The cellular phone 112 may then run a text-to-speech program to convert the text and symbols identified within the captured image to an audio file so the text may be broadcast as audio by a compatible device. The cellular phone 112 may then play the audio file via a device for playing audio, thus allowing the user of the ring 104 to understand the text and symbols displayed on the handout presented to the user. The system 100 comprising a device from the group of mobile devices 102 and a device from the group of processing devices 110 may thus be used by a person having visual impairments to “read” text or symbols which he or she would be unable to understand otherwise.

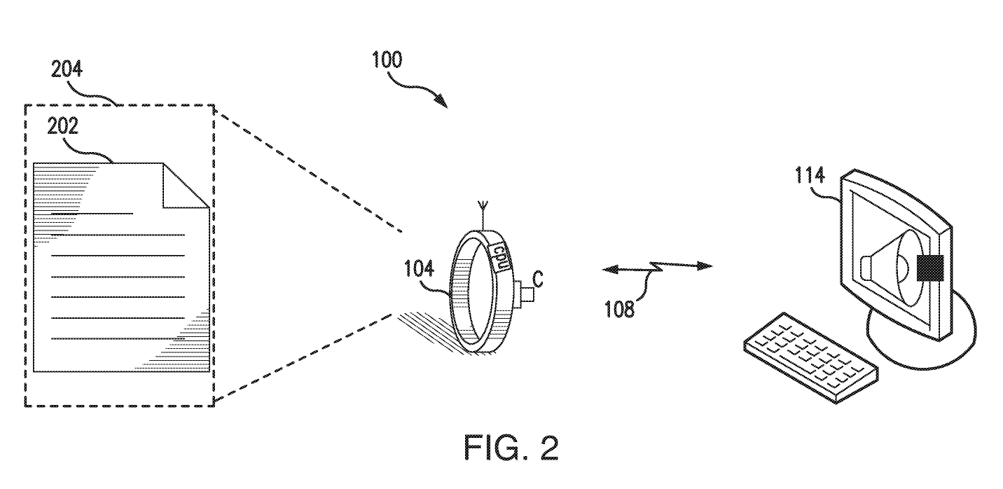

FIG. 2 is a schematic diagram of the system 100 comprising the ring 104 and the computer 114, configured to convert observed text or symbols to audio, in accordance with an exemplary implementation. The diagram depicts the ring 104 comprising the camera (C), the controller (CPU), the antenna of the transceiver, and the various other components, the computer 114, a visual representation of the communication path 108, and a handout 202 comprising text and/or symbols.

The ring 104 and the handout 202 may be shown in relation to imaging constraints 204 of the camera of the ring 104. As described above, the ring 104 may be configured to capture an image of the handout 202 and the text and/or symbols contained thereon. The captured image may be communicated to the computer 114 via the communication path 108, where the captured image may be converted into an audio file. The computer 114 may then play the audio file for the user so as to communicate the text and symbols to the user. The imaging constraints 204 of the camera of the ring 104 may comprise limits of the camera of the ring 104 to capture images that may be analyzed and converted to audio files. For example, in some embodiments, the imaging constraints 204 may comprise the focus limits or the field of view of the camera of the ring 104, among others, where outside the box indicated by the imaging constraints 204, the camera is unable to capture text that can be converted to audio for playback to the user. For example, when a portion of the handout 202 falls outside the imaging constraints 204 of the camera of the ring 104, text on the portion of the handout 202 may be out of focus or may be outside of the area captured by the camera of the ring 104 and, thus, the text and/or symbols of the portion of the handout 202 cannot be converted to audio for playback for the user. In some embodiments, the ring 104 may have one or more components for alerting the user when the target handout 202 or other item having text and/or symbols is within the imaging constraints, partially within the imaging constraints, or entirely outside the imaging constraints. For example, the ring 104 may be configured to vibrate in a predetermined pattern when the target handout is within the imaging constraints. The ring 104 may also be programmed to vibrate with a different predetermined pattern when the target handout is outside the imaging constraints. The ring 104 may also contain a speaker or other auditory device to provide auditory feedback to indicate to the user when the target handout is within the imaging constraints.

In some embodiments, the computer 114 (or other device of the group of processing devices 110, as referenced in FIG. 1) may be used to communicate the captured image or converted audio file to other users, or to save the captured image or converted audio file for later reference. In some embodiments, as will be discussed in further detail below, the computer 114 may be used to manipulate the audio file, for example translating it between different languages. Additionally, the computer 114 may be used to combine multiple audio files into a single audio file, such that multiple images may essentially be combined into a single item (for example, multiple pages of a single document, captured as multiple images, may be combined into a single audio file representing the single document).

In relation to an example provided above, the ring 104 may be configured to automatically function with a computer 114. For example, the ring 104 may allow the user to capture an image and transmit the image for processing in conversion to the computer 114. This may occur while the user is using the computer for another purpose, for example typing a report or paper, browsing the Internet, or playing again, among others. The computer may then play the audio for the user via various hardware. Such background processing may allow the system 100 to be more efficient and allow the user to multi-task and be more efficient.

In some embodiments, the MB 102 may be integrated with the PD 110. For example, the computer 114 of FIG. 2 may be integrated into the ring 104, such that the user only needs a single device capable of capturing the image of the text, converting the image to audio, and playing back the audio to the user. Such integration may minimize the number of devices the user must carry with them and may simplify the process of converting text to audio for playback to the user.

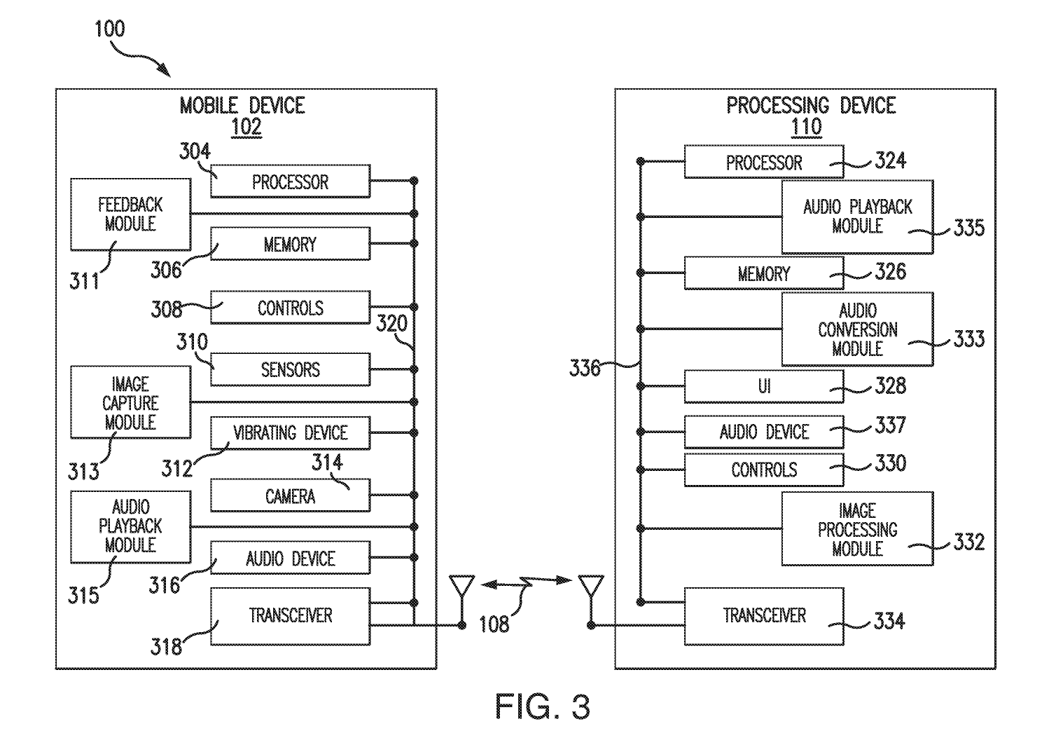

FIG. 3 shows an exemplary functional block diagram of the processing system 100 for observing and capturing text and providing audio playback of the captured text, the processing system comprising a mobile device (MD) 102 configured to communicate with a processing device (PD) 110, both as referenced in FIGS. 1 and 2. However, as described above, the MD 102 and the PD 110 may be integrated or combined into a single, mobile device (not shown in this figure). If combined, one or more of the components shown in FIG. 3 may be eliminated and/or integrated with another component.

As shown, the MD 102 may be configured to perform the processes and methods disclosed herein. The MD 102 is an example of a device that may be configured to capture an image of an item comprising text (for example, a page with writing, a menu, a computer screen, a sign, etc.) and save the image locally or transmit the image to the PD 110. The PD 110 may process the image to identify text in the image and may provide to the MD 102 an audio conversion of the text in the image. The MD 102 may then play the audio conversion for a user of the device, thereby allowing the user to hear the text captured in the image. The components described below and as shown in FIG. 3 may be indicative of components used in various embodiments of the invention disclosed herein. However, some embodiments may include additional components not shown in this figure or may have fewer components than shown in this figure.

The MD 102 comprises a processor 304 configured to process information in the MD 102 and a memory 306 to save and/or retrieve information in the MD 102. The MD 102 also comprises controls 308 to allow the user to interact with the MD 102, sensors 310 to allow the MD 102 to be aware of an operational environment, and a vibrating device 312 to allow the MD 102 to provide haptic feedback to the user. The MD 102 further comprises a camera 314 to capture images of items comprising text and an audio unit 316 configured to play audio (for example, a speaker). The MD 102 also includes a transceiver 318 for communicating information with the PD 110, and a bus system 320 for handling transportation of signals within the MD 102.

The MD 102 also has a feedback module 311, an image capture module 313, and an audio playback module 315 for handling various inputs and signals received. The feedback module 311 may be configured to control a feedback process from the MD 102 to the user. In some embodiments, the feedback may include physical or audio feedback based on events or conditions identified by the MD 102. Alternatively, or additionally, the feedback controlled by the feedback module 311 may include playing of audio files corresponding to text identified in captured images.

The image capture module 313 may be configured to control an image capture process. The image capture process may include the process of aligning the MD 102 with the text to be captured and capturing an image containing the desired text. The audio playback module 315 may be configured to control the playback to the user of audio files corresponding to text of the captured images. In some embodiments, the feedback module 311, the image capture module 313, and the audio playback module 315 may utilize signals and/or commands from one or more of the other components of the MD 102 or may utilize one or more other components of the MD 102 to perform their associated functions. In some embodiments, the feedback module 311, the image capture module 313, and the audio playback module 315 may be used independently of each other or in combination with each other.

In some embodiments, the processor 304 is configured to control the operation of the MD 102. The processor 304 may be referred to as a central processing unit (CPU). The processor 304 may be a component of a processing system implemented with one or more processors. The processor 304 may have one or more processors that may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processor 304 may be configured to execute instructions or software stored on machine-readable media. Instructions and/or software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processor 304, cause the processing system to perform the various functions described herein.

As discussed above, the MD 102 may include the memory 306. The memory 306 may include both read-only memory (ROM) and random access memory (RAM) and may provide instructions and data to the processor 302. For example, in some embodiments, the instructions or software described above may be stored in the memory 306. In some embodiments, the memory 306 may be operably coupled to the processor 302. A portion of the memory 306 may also include non-volatile random access memory (NVRAM). In some embodiments, the memory 306 may be removable, for example, a secure digital (SD) card, universal serial bus (USB) drive, or compact flash (CF) card. The processor 302 typically performs logical and arithmetic operations based on program instructions stored within the memory 306 or some other machine-readable media. The instructions in the memory 306 (or the other machine-readable media) may be executable to implement the methods described herein.

The MD 102 may further include the controls 308. The controls 308 may be configured to allow the user to interact with the MD 102. For example, the controls 308 may include one or more buttons to activate the ability for the mobile scanning device 102 to capture an image of text or to activate a text identifying system (as discussed below). Additionally, the controls 308 may include controls for the feedback unit 312 or controls for the audio unit 316. In some embodiments, the controls 308 may be integrated with one or more of the feedback module 311, the image capture module 313, and the audio playback module 315 so as to control the functions of the one or more modules.

In some embodiments, the controls 308 may allow the user to control the volume of audio from the audio device 316 (for example, increase or decrease the volume) or control the speed of the audio playback (for example, increase or decrease the speed of the playback). In some embodiments, the controls 308 may include a power button (or similar control) to allow the user to turn off the MD 102 to conserve power. Alternatively, or additionally, the controls 308 may include one or controls to allow the user to activate voice commands for the MD 102 or to save the captured image or converted audio file (or access a saved image or audio file). In some embodiments, the controls 308 may allow the user to customize use of the MD 102 as the user desires. In some embodiments, the controls 308 may be used to control any of the other components of the MD 102.

The MD 102 may also include one or more sensors 310. The sensors 310 may include, but are not limited to, orientation sensors (for example gyroscopes or levels), audio sensors, optical sensors, ultra- or supersonic sensors, or any other sensors that may be useful in identifying and capturing text or identify items comprising text in a controlled, consistent manner. In some embodiments, the sensors 310 may include one or more sensors configured for safety during the user of the MD 102, for example a temperature sensor, a proximity sensor, or a motion sensor. Inputs from the sensors 310 may be communicated to one or more of the processor 304, the memory 306, the feedback module 311, the controls 308, the image capture module 313, the audio playback module 315, and the transceiver 318, among others.

The sensors 310 may be configured to assist the user of the MD 102 to capture text. For example, the sensors 310 may be configured to identify edges of a sheet of paper or a handout being captured by the MD 102, such that the MD 102 may use the feedback module 311 to indicate to the user when the entire sheet is being captured by the camera 314 or how the user should maneuver the MD 102 to capture the entire sheet. In another embodiment, the sensors 310 may be configured to identify edges of a sign to indicate when the user has the entire sign in a field of view of the camera 314. Alternatively, or additionally, the sensors 310 may be configured to indicate when the MD 102 is being held level with the text being captured such that all of the target text is captured in an understandable manner (for example, indicating when a page is properly oriented) or so that the captured text image can be more easily processed to appropriately identify the text.

In some embodiments, when used for safety, the sensors 310 may be configured to identify excessive heat or movement so that the user of the mobile scanning device 102 can be warned of use or proximity of dangerous conditions. For example, if the device is used to read markings on packaging of a food product, the sensors 310 may indicate to the user that the product is hot to the touch, etc., so the user's use of the MD 102 does not endanger the user.

The vibrating device 312 of the MD 102 may include a haptic or other tactile feedback device. The vibrating device 312 may be configured to provide a physical signal or indication to the user. For example, the vibrating device 312 may be configured to vibrate in response to a received signal or may otherwise provide feedback that a user can feel physically. In some embodiments, the vibrating device 312 may receive a signal or a command from one or more of the processor 304, the memory 306, the controls 308, the feedback module 311, the sensors 310, the image capture module 313, the camera 314, and the transceiver 318, among others.

The camera 314 of the MD 102 is configured to capture one or more images of items in a field of view of the camera 314. The camera 314 may receive a signal to capture an image from one or more of the processor 304, the image capture module 313, and the transceiver 318, among others. The signal may instruct the camera 314 to capture one or more images. In some embodiments, the signal may instruct the camera 314 to capture a video. It should be realized that the term “signal” may also include software or hardware commands.

The captured images or video may be one or more of saved in the memory 306, processed by the processor 304, processed by the image capture module 313, or communicated via the transceiver 318. In some embodiments, the camera 314 may be configured to automatically focus on one or more items in the field of view and/or may be configured to receive focus signals from one or more of the processor 304, the memory 306, the controls 308, and the image capture module 313, among others.

The MD 102 further includes the audio device 316. The audio device 316 may comprise one or more devices, such as a speaker, to generate auditory output in response to signals received. In some embodiments, the audio device 316 may comprise a device that generates an audio signal for playback in response to a received input signal. In some embodiments, audio signals or input signals may be generated by one or more of the components of the MD 102, for example the processor 304, the memory 306, the feedback module 311, the controls 308, the audio playback module 315, and the transceiver 318, among others.

The transceiver 318 of the MD 102 may be configured to directly or wirelessly communicate information between the MD 102 and other devices, for example the PD 110. The communication may be through well-known standards, for example Bluetooth, Wi-Fi, Infra-Red, near field communication (NFC), and radio frequency identification (RFID). The transceiver 318 may be configured to both transmit and receive information along communication path 108. The information that the transceiver 318 communications may be received from or communicated to any of the components of the MD 102, including, for example, the processor 304, the memory 306, the feedback module 311, the controls 308, the image capture module 313, the camera 314, and the audio playback module 314.

The bus 320 provides a connection that enables the various components of MD 102 to communicate with each other. The bus 320 may include a data bus, for example, as well as a power bus, a control signal bus, and a status signal bus.

As described above, the feedback module 311 may be configured to control a feedback process from the MD 102 to the user. Thus, any feedback to the user (for example indication of information sent/received via the transceiver 318, event sensed by the sensors 310, image captured by the camera 314 or focusing of the camera 314, etc.) may be controlled by the feedback module 311. The feedback module 311 may have one or more components programmed, or otherwise configured, to provide feedback based on the use of the MD 102. For example, if the MD 102 is configured to provide feedback to the user based on certain conditions (for example when an image is being captured or audio is ready for playback to the user), then the feedback module 311 may control the determination of need for and execution of such feedback. For example, the feedback module 311 may be configured to receive one or more signals from one or more of the components of the mobile device 102 and generate feedback to the user via one or more of the audio device 316 or the vibrating device 312 based on the received signals. In some embodiments, if the feedback module 311 generates audio feedback, the feedback module 311 may communicate with the audio playback module 315 via the bus 320. Similarly, if the feedback module 311 generates haptic or physical feedback, the feedback module 311 may communicate with the vibrating device via the bus 320. In some embodiments, the feedback module 311 may utilize the processor 304 to perform necessary tasks, while in some embodiments, the feedback module 311 may have its own controller or processor (not shown in this figure).

In some embodiments, the feedback module 311 may operate as a controller between the components of the MD 102 that may request feedback be provided to the user and the components of the MD that perform the feedback to the user. Accordingly, the feedback module 311 may receive an input from the camera 314 indicating that a haptic feedback signal should be provided to the user to indicate that the camera 314 just captured an image, and the feedback module 311 will direct an output to the vibrating device 312 according to the input received.

Alternatively, or additionally, the feedback module 311 may operate to identify necessary feedback conditions based on inputs received from various components of the MD 102. The feedback module 311 may also control one or more other components to generate appropriate feedback to the user based on the inputs received. For example, the sensors 310 may be controlled by the feedback module 311 such that feedback is provided to the user based on information received from the sensor 310. If the sensors 310 identify that the user of the MD 102 is not capturing a whole page with the camera 314 (for example, a portion of the page is cut off due to the way the user is maneuvering the MD 102), the feedback module 311 may be configured to generate an indication of such a scenario to the user. For example, the indication may comprise either audio or haptic feedback, where a single tone or single patterned haptic signal indicates proper alignment, while repeated tones or repeated patterned haptic signal indicates improper alignment. Alternatively, or additionally, the feedback module 311 may receive a signal from the transceiver 318 indicating an audio file was received from the PD 110, and the feedback module 311 may determine that such a condition (receipt of audio file) should generate an audible or haptic feedback to the user. Accordingly, the feedback module 311 may select the audible or haptic feedback independent of any indication from the received signal.

As described above, the image capture module 313 may be configured to control an image capture process of the MD 102. The image capture module 313 may comprise one or more components programmed or otherwise configured to provide control of the image capture process of the MD 102. In some embodiments, the image capture process controlled by the image capture module 313 may comprise activating the camera 314, focusing the camera 314 and otherwise preparing the camera 314 to capture an image, capturing an image with the camera 314, and saving the captured image to the memory 306 or communicating the captured image to the transceiver 318. In some embodiments, the image capture module 313 may be configured to operate as the controller for the image capture process or may operate as more of a buffer in the image capture process. Accordingly, all functions associated with capturing an image may be controlled by the image capture module 313.

For example, when configured to operate as the controller for the image capture process, the image capture module 313 may be configured to receive one or more inputs from one or more components of the MD 102 and determine what actions to take based on the one or more received inputs. For example, if the user uses one of the controls 308 to turn on the camera 314, then the image capture module 313 (acting as the controller) may command the camera 314 to activate. Similarly, if the user selects one of the controls 308 to capture an image of the field of view of the camera 314, then the image capture module 313 may command the camera 314 to activate, to focus on the current field of view, and to capture an image of the field of view. When the camera 314 captures the image, the image capture module 313 may generate an output to the audio device or the vibrating device to indicate to the user that the camera captured an image. The image capture module 313 may then communicate the captured image to memory 306 for temporary storage until the image capture module 313 receives a command (via an input) to save the image, communicate the image, or delete the image.

When configured to operate as a buffer in the image capture process, the image capture module 313 may be configured to perform specific actions in response to specific inputs. For example, if the image capture module 313 receives an input to capture an image, the image capture module 313 may output a command to the camera 314 to capture an image, but may not ensure that the camera is activated and focused on the field of view.

The audio playback module 315 may be configured to control an audio playback process that broadcasts audio files to the user of the MD 102. The audio playback module 315 may include one or more components programmed, or otherwise configured, to provide control of the audio playback process of the MD 102. In some embodiments, the audio playback process controlled by the audio playback module 315 may access the audio file to be played, activate the audio device 316, and output a sound using the audio device 316. In some embodiments, the audio playback module 315 may be configured to operate as the controller for the audio playback process or may operate as more of a buffer in the audio playback process. Accordingly, all functions associated with broadcast or playback of audio files may be controlled by the audio playback module 315.

For example, when operating as a controller of the audio playback process, the audio playback module 315 may monitor the user's receipt and playback of audio files or may control a playback of audio files based on the actions of the user with the MD 102. For example, if the user is playing an audio file, the audio playback module 315 may control the accessing and playing of the audio file, as well as monitor the controls 308 that the user may use while playing the audio file. For example, if the user activates a control 308 to increase volume, then the audio playback module 315 may increase the volume via the audio device 316. Similarly, if the pauses the playback (or rewinds, increases/decreases speed), then the audio playback module 315 may control the appropriate component based on the user's inputs via the control 308 (for example, the audio playback module 315 may control the processor 304 performing decoding of the audio file to reduce playback speed if so requested by the user). In some embodiments, the audio playback module 315 may be configured to interrupt existing audio being played by the audio device 316. In some embodiments, the audio playback module 315 may be configured to be overlay audio with existing audio. In some embodiments, the interrupt a file transfer or other use of the transceiver 334 of the processing device 110 such that priority is given to images received from the mobile device 102. In some embodiments, the interrupt of the processing device 110 by the mobile device 102 may be prompted on the UI 328 of the processing center.

In some embodiments, the feedback module 311, the image capture module 313, and the audio playback module 315 may be configured to monitor each other such that one or more of the modules do not try to simultaneously use the same component of the MD 102. Similarly, the modules and the other components of the MD 102 may monitor each other such that no component receives or sends conflicting signals at one time. For example, the feedback module 311 may monitor the audio device 316 so that the feedback module 311 does not command the audio device 316 to play an audio feedback signal while the audio playback module 315 is using the audio device 316 to play an audio file.

The PD 110 may comprise one or more processors 324, a memory 326, a user interface 328, controls 330, a transceiver 334, an audio conversion module 333, an image processing module 332, an audio playback module 335, and an audio device 337. The processors 324, the memory 326, the controls 330, the transceiver 334, the audio playback module 335, and the audio device 337 may be similar to the corresponding components of the MD 102. The user interface (UI) 328 may comprise a screen or other interface generally used to provide information to the user of the PD 110. In some embodiments, the UI 328 may be integrated with the controls 330 such that the interface can provide information to and receive information from the user of the PD 110. In some embodiments, the audio device 337 may include a Bluetooth headset, or pair of head phones, a speaker, etc. When the audio device 337 includes a wireless device, the audio device 337 may operate in conjunction with the transceiver 334, which may be configured to transmit information wirelessly to a Bluetooth headset or other wireless device that will allow the user to listen to the audio file.

The image processing module 332 may be configured to control an image processing process of the PD 110. The image processing module 332 may comprise one or more components programmed or otherwise configured to provide control of the image processing process of the PD 110. The image processing process may be used to receive a captured image communicated to the PD 110 from the MD 102 via the transceiver 334, and identify within the captured image text and symbols to convert to audio using the audio conversion module 333. The image processing module 332 may identify text within the captured image via any known methods (for example, OCR, etc.). In some embodiments, the image processing module 332 may be configured to operate as the controller for the image processing process or may operate as more of a buffer in the image processing process. Accordingly, all functions associated with processing an image may be controlled by the image processing module 332.

For example, when configured to operate as the controller for the image processing process, the image process module 332 may be configured to receive one or more inputs from one or more components of the PD 110 and determine what actions to take based on the one or more received inputs. For example, if the user uses one of the controls 308 to begin image processing, then the image processing module 332 (acting as the controller) may command the processor 324 (or other component of the PD 110) to begin processing the indicated image. Similarly, if the user selects one of the controls 308 to cancel image processing, then the image processing module 332 may command the processor 324 (or other component of the PD 110) to stop processing the indicated image and instead save the partial processed information to memory 326. The image processing module 332 may be configured to receive the image from the transceiver 334 and either store it in memory 326 for later processing or immediately process it. If immediately processing the received image, the image processing module 332 may use internal components or components of the PD 110 (for example processor 324) to process the image to detect and analyze text and/or symbols. Once the received image is processed (or while the image is being processed), the image processing module 332 may be configured to save the processed information in the memory 326 or pass the processed information on to the audio conversion module 333. Additionally, or alternatively, the image processing module 332 may monitor the controls 330 to identify if any commands entered by the user via the controls 330 affect the image processing process. Additionally, the image processing module 332 may provide information to the UI 328 to update the user of the status of the image processing process. Additionally, or alternatively, the image processing module 332 may manage the images and processed information stored in the memory 326, thus controlling when and where the images and/or information are stored and/or deleted from memory or communicated to the MD 102 via the transceiver 334.

The audio conversion module 333 may be configured to control an audio conversion process of the PD 110. The audio conversion module 333 may comprise one or more components programmed or otherwise configured to provide control of the audio conversion process of the PD 110. The audio conversion process may be used to receive processed information of an image containing text and/or symbols, convert the identified words from the processed information into audio, and then combine the audio of all the identified words from the image into a single audio file. Then the audio conversion process may save the audio file in the memory 326 or communicate the audio file to the MD 102 via the transceiver 334. The audio conversion module 333 may convert the text within the processed information to audio via any known methods (for example, text-to-speech, etc.). In some embodiments, the audio conversion module 333 may be configured to operate as the controller for the audio conversion process or may operate as more of a buffer in the audio conversion process. Accordingly, all functions associated with converting text in the image to audio may be controlled by the audio conversion module 333.

For example, when configured to operate as the controller for the audio conversion process, the audio conversion module 333 may be configured to receive one or more inputs from one or more components of the PD 110 and determine what actions to take based on the one or more received inputs. For example, if the user uses one of the controls 308 to begin converting an image or information from an image into audio, then the audio conversion module 333 (acting as the controller) may command the processor 324 to begin converting the text of the indicated image to audio. Similarly, if the user selects one of the controls 308 to cancel audio conversion, then the audio conversion module 333 may command the processor 324 to stop converting the text of the indicated image to audio and instead save the partial audio conversion to memory 326. The audio conversion module 333 may be configured receive the image or the processed information after the image is processed by image processing module 332 from the memory 326.

The audio conversion module 333 may use internal components or components of the PD 110 (for example processor 324) to convert the text and/or of the images of the processed information to audio. Once the image and/or the processed information is converted to audio (or while it is being converted to audio), the audio conversion module 333 may be configured to save the converted audio in the memory 326 or pass the converted audio on to the transceiver 334. Additionally, or alternatively, the audio conversion module 333 may monitor the controls 330 to identify if any commands entered by the user affect the audio conversion process. Additionally, the audio conversion module 333 may provide information to the UI 328 to update the user of the status of the audio conversion process. Additionally, or alternatively, the audio conversion module 333 may manage the audio files and the audio conversion information stored in the memory 326, thus controlling when and where the audio files and/or conversion information are stored and/or deleted from memory or communicated to the MD 102 via the transceiver 334. In some embodiments, the audio conversion module 333 may be configured to play the audio file via the UI 328 while the image and/or processed information is converted to audio or to play an audio file saved in the memory 326.

Although a number of separate components are illustrated in FIG. 3, one or more of the components may be combined or commonly implemented. For example, the processor 304 may be used to implement not only the functionality described above with respect to the processor 304, but also to implement the functionality described above with respect to the controls 308 and/or the sensors 310 and/or one of the modules 311, 313, and 315. Likewise, the processor 324 may be used to implement not only the functionality described above with respect to the processor 324, but also to implement the functionality described above with respect to the UI 328 and/or the controls 330 and/or modules 332 and 333. Further, each of the components illustrated in FIG. 3 may be implemented using a plurality of separate elements.

In operation, the system 100 may be configured to seamlessly integrate with existing equipment and items to provide an end-to-end solution. For example, the mobile device 102 may comprise the ring 104 described above in relation to FIGS. 1 and 2. As shown in FIGS. 1-3, the ring 104 may include the camera 314 and the antenna of the transceiver 318, among other components (as shown in FIG. 3), such as controls 308. The user may also have a cellphone 112 including an application that configures the cellphone 112 to function as processing device 110. In some embodiments, the application may be configured to run in the background such that the cellphone 112 may be used for other functions for which the cellphone 112 was designed to perform (for example making calls, browsing the Internet, or running other apps, etc.). Thus, the application described herein may not restrict or otherwise disable the use of cellphone 112 for other purposes in conjunction to the processing device 110 purposes. Furthermore, the use may have headphones physically connected to the cellphone 112 or wirelessly connected to the cellphone 112 (for example, via Bluetooth, Wi-Fi, etc.).

When the user is presented with an item including text that the user desires to “read,” the user may point the camera 314 of the ring 104 at the item that the user desires to capture in an image, and may use controls 308 to activate the camera 314 to capture the image. The ring 104 may then automatically transmit the captured image, using its transceiver 318 and associated antenna, to the transceiver 334 of the cellphone 112. The app on the cellphone 112 may automatically detect the receipt of the captured image from the ring 104 and may activate the image processing and audio conversion modules 332 and 333, respectively. The app on the cellphone 112 may then work in the background on the cellphone 112 to identify the text captured in the image (via the image processing module 332) and convert the identified text to audio (via the audio conversion module 333). Working in the background may allow the user to continue to use the cellphone 112 for other purposes.

Once the cellphone 112 identifies the text captured in the image and converts the identified text to audio, the cellphone 112 may use the audio playback module 335 to play the audio for the user via the Bluetooth headset or the connected headphones. In some embodiments, the audio playback module 335 may be configured to interrupt any processes of the cellphone 112 and/or the Bluetooth headset or connected headphones to play the audio for the user. In some embodiments, the audio playback module 335 may be configured to overlay the audio being played by the application over any existing operations of the Bluetooth headset or connected headphones. For example, if the user is on a phone call, then the audio playback module 335 may be configured to play the audio over the phone call such that the user can hear both the phone call and the audio from the text at the same time. In some embodiments, the audio playback module 335 may be configured to isolate the audio playback to one or more channels (for example a left/right channel). The UI 328 and the controls 330 may allow the user to control the ability for the audio playback module 335 to interrupt other functions on the cellphone 112 or may control the ability for the image processing and audio conversion modules 332 and 333, respectively, to operate in the background.

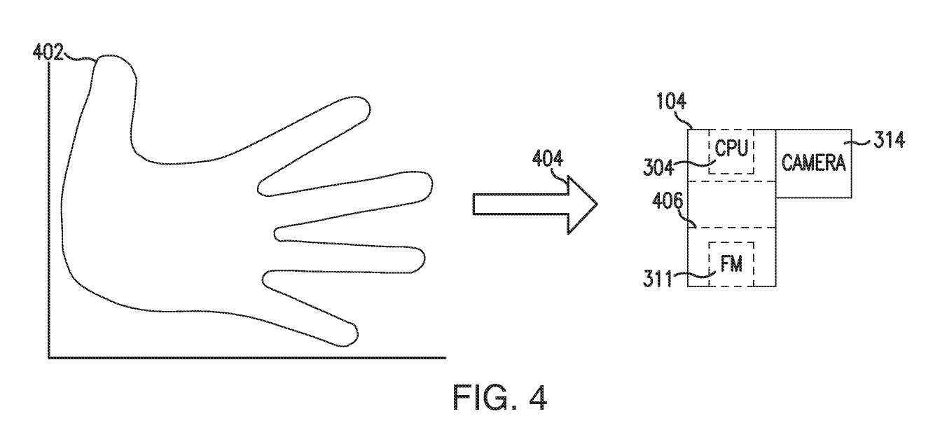

FIG. 4 shows a schematic of an embodiment of the MD 102 as the ring 104 as it may be placed on user's hand/finger 402, in accordance with an exemplary embodiment. The ring 104 may contain one or more of the components described above in reference to FIG. 3. For example, the ring 104, as shown in FIG. 4, has the camera 314, the processor 304, and the antenna of the transceiver 318. The ring 104 may also have one or more of the other components described in FIG. 3, though not illustrated in FIG. 4. The ring 104 also shows a channel 406 that passes through the ring 104. The channel 406 may allow the user's finger to pass through the ring 104 such that the ring 104 can be worn on the user's hand/finger 402. The arrow 404 indicates that the user may place his finger, or fingers, through the channel 406.

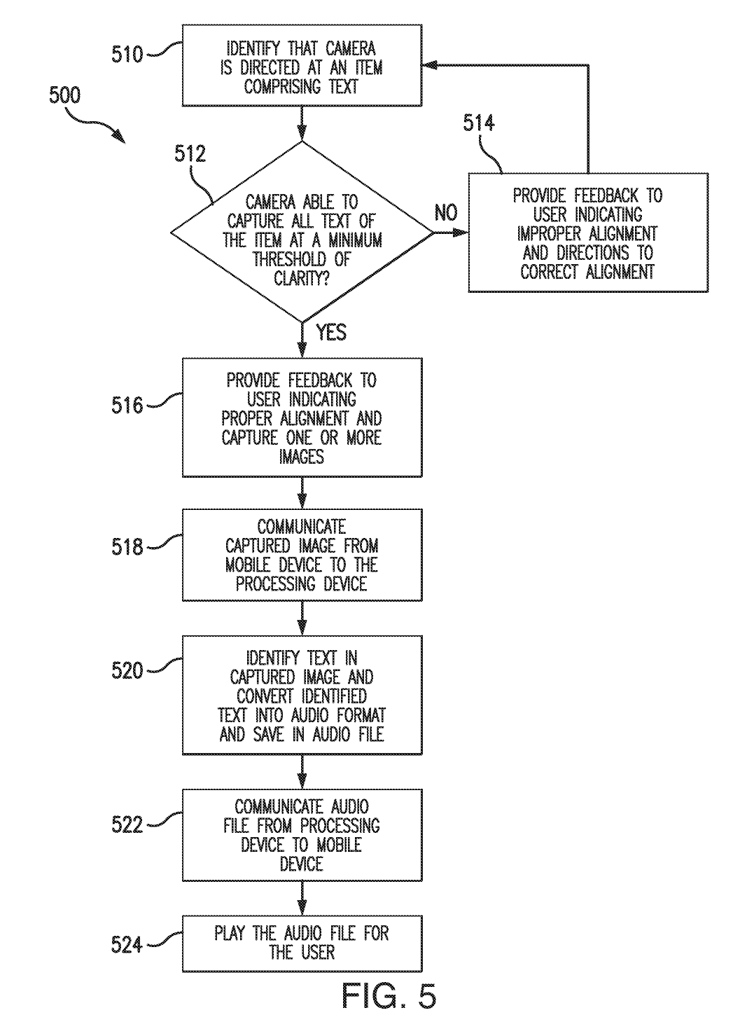

FIG. 5 is a flowchart depicting a method for observing text and/or symbols and converting them to audio for playback to a user, in accordance with an exemplary implementation. As shown, method 500 begins at block 510, where the MD 102 (as referenced in FIGS. 1-3) identifies that the camera of the MD 102 is directed toward an item containing text that the user wishes to understand. For example, with reference to the ring 104 as referenced in FIG. 4, when the user receives a piece of paper with text on it, the user may direct the camera of the ring 104 toward the paper and activate a button or other control indicating that the camera is directed toward an item comprising text. This indication may cause the camera and/or sensors of the ring 104 to identify the location of the paper with the text. This may be done by, for example, identifying the edges of the paper as those edges contrast with the surface where the paper is resting. Then, the method 500 may proceed to block 512.

At block 512, the method 500 determines if the camera is able to capture all the text on the paper at a minimum threshold of clarity and quality. This determination may be made by comparing the captured resolution with a preset threshold to determine if the text on the paper was captured with enough resolution to convert the captured image to text with a minimum level of accuracy. Such a determination may be performed using the camera itself and/or the sensors of the ring 104. For example, the sensors may determine that at least a portion of the paper it outside the range of the camera, and thus may determine that all the text cannot be captured by the camera. Alternatively, or additionally, the camera may scan the paper (or take a preliminary image capture of the paper) and determine if a quality or clarity of the text in the scan or preliminary capture is sufficient to convert to text. If the sensors and/or the camera determine that the camera can capture all the text of the item at a minimum threshold of clarity and quality, then the method 500 progresses to block 516. If the sensors and/or camera determine that the camera cannot capture all of the text of the item at the minimum threshold of clarity/quality, then the method 500 progresses to block 514.

At block 512, if the sensors and/or camera determine that the paper is too large to capture in a single image with the text clear enough to be processed, then the method 500 may provide notification of such issue to the user (not shown in this figure). The method 500 may then direct the user to take multiple images of the page and then reconstruct (for example, stitch) the multiple images together to form a single large image (also not shown in this image). Once the single image is generated, the method 500 proceeds to block 518.

At block 514, the method 500 provides feedback to the user indicating improper alignment of the paper and/or directions to correct alignment of the paper and/or direction to capture all the text of the paper at the minimum threshold. The feedback provided may be controlled by the feedback module of the MD 102. For example, the vibration or audio may vibrate or provide an audio indicator, respectively, to instruct the user how to reposition the paper and/or the camera to be able to capture the entire paper with the proper clarity and alignment. Once the paper and/or camera are repositioned, then the method 500 returns to block 510.

At block 516, the method 500 provides feedback to the user indicating that the paper and camera are properly aligned and captures an image. The feedback provided to the user may comprise an audible indicator or a physical (for example, haptic) indicator. For example, the audible indicator may be similar to a note, buzzer, or bell sound. Additionally, when the method 500 captures the image at block 516, feedback of the image capture may be provided. For example, the audible indicator may comprise a shutter sound of a camera, while the haptic indicator may be a series or pattern of vibrations, distinct from other series or patterns of vibrations. The capture of the image may utilize the image capture module of the MD 102, and the feedback indicators may utilize the feedback module of the MD 102. Once the image is captured, the method 500 proceeds to block 518.

At block 518, the method 500 may communicate the captured image from the MD 102 to the PD 110. For example, the image captured by the camera may be temporarily stored in the memory of the MD 102. The image captured may then be communicated to the transceiver of the MD 102 so that it may be transmitted to the PD 110, where image processing by the image processing module and audio conversion by the audio conversion module may take place. Such communication to the transceiver may comprise use of the processor and the bus of the MD 102. In embodiments where the MD 102 and PD 110 are integrated into a single device, the communication of the captured image may skip the transceiver and instead be stored into memory before being processed by the by the image processing module. Once the captured image is communicated from the MD 102 to the PD 110, the method 500 proceeds to block 520.

At block 520, the method 500 identifies text in the captured image and converts the identified text into an audio file. The method 500 may receive the image transmitted from the transceiver of the MD 102 at the transceiver of the PD 110. The image may then be stored temporarily in the memory of the PD 110 before being processed by the image processing module. Alternatively, the image may be communicated directly to the image processing module of the PD 110. The image processing module of the PD 110, as described above, may identify text in the image and may generate image information comprising the text in the image. This image information may then be stored in memory before being processed by the audio conversion module of the PD 110, or may be communicated directly to the audio conversion module of the PD 110. The audio conversion module of the PD 110 may then convert the image information to audio and save the audio in an audio file in the memory of the PD 110. The audio conversion module may be configured to convert the image information (containing the text of the image) into any output language so that it may be understood by someone who cannot understand the language in which the text was written. Once the image has been processed to identify text contained therein, and the identified text has been converted to audio and saved in an audio file, the method 500 proceeds to block 522.

At block 522, the method 500 communicates the audio file from the PD 110 to the MD 102. This communication may comprise transmitting the audio file from the memory of the PD 110 to the MD 102 via the transceiver of the PD 110, using one of the communication paths described above. If the MD 102 and the PD 110 are integrated into a single device, then this block of the method 500 may no longer be necessary. Once the MD 102 receives the audio file from the PD 110, the audio playback module of the MD 102 may handle the audio file. The audio playback module may save the audio file in the memory of the MD 102 for later playback, or may use the processor and audio device of the MD 102 to playback the audio file immediately. The audio playback module may be controlled via the controls of the MD 102 to allow the user to manipulate the playback of the audio file. Once the audio playback module receives the audio file, the method 500 proceeds to block 524.

At block 524, the audio playback module may play the audio file for the user. The audio playback module may be controlled via the controls of the MD 102 to allow the user to manipulate the playback of the audio file. Once the user has listened to the file, or if the user stops the playback before completing the audio file, the user may save the audio file in the memory of the MD 102 for later playback. Alternatively, the user may share the audio file via the transceiver of the MD 102 for playback by other users or for sharing via social media, etc.

Though not shown in FIG. 5, the method may function in accordance with the description above in relation to FIG. 3. For example, the camera on the ring may be activated to capture an image using a control (for example, a button). The camera may then capture the image and communicate the image to the transceiver to be transmitted to the cell phone. The transceiver of the cell phone may receive the image and may process the image to identify text in the image (via the processor and the image processing module) and convert any identified text to audio (via the processor and the audio conversion module). Then the cell phone may then transmit the converted audio to the user via a Bluetooth headset, a speaker, wired headphones, etc.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations. For example, a means for selectively allowing current in response to a control voltage may comprise a first transistor. In addition, means for limiting an amount of the control voltage comprising means for selectively providing an open circuit may comprise a second transistor.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions may not be interpreted as causing a departure from the scope of the implementations of the invention.

The various illustrative blocks, modules, and circuits described in connection with the implementations disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the implementations disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor may read information from, and write information to, the storage medium. In the alternative, the storage medium may be integral to the processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above may also be included within the scope of computer readable media. The processor and the storage medium may reside in an ASIC. The ASIC may reside in a user terminal. In the alternative, the processor and the storage medium may reside as discrete components in a user terminal.

For purposes of summarizing the disclosure, certain aspects, advantages and novel features of the inventions have been described herein. It is to be understood that not necessarily all such advantages may be achieved in accordance with any particular implementation of the invention. Thus, the invention may be embodied or carried out in a manner that achieves or optimizes one advantage or group of advantages as taught herein without necessarily achieving other advantages as may be taught or suggested herein.

Various modifications of the above described implementations will be readily apparent, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. A portable device for enabling a user having visual impairments to understand written text material, comprising:
a housing configured to be worn by the user;
an image capture module mounted in the housing and configured to capture images of text material;
a processor, configured to convert the images of text material into text data and transmit the text data to a portable device;
a vibrating device configured to provide haptic feedback relating to the control of the image capture.

2. A method for enabling a user having visual impairments to understand written text material, comprising:
initializing an image capture process on a device configured to be worn by a user
determining if the image capture process has captured a full image of a target page of text, wherein if the image capture process has not captured a full image, outputting a first haptic feedback, and wherein if the image capture process has captured a full image, outputting a second haptic feedback;
communicating the captured image to a second device via a wireless communication medium for processing of the captured text.

3. A system for allowing a blind or low vision user to perceive text associated with various types of objects, each object type having an associated image constraint, the system comprising:
a ring (104) with a central channel (406) for permitting the ring (104) to be worn upon the finger of the user, the ring (104) housing a processor (304), a memory (306), sensors (310), a haptic feedback device (312), a camera (314) having a field of view, controls (308), and a transceiver (318), the camera (314) capturing an image of the object, the sensors (310) and the processor (304) processing the captured image and determining the object type and whether the captured image is within the associated image constraint, the haptic feedback device (312) generating a vibration if the image is within the associated image constraint;
a cellular telephone (112) housing a processor (324), a memory (326), an audio playback module (335), an audio conversion module (333), an image processing module (332), and a transceiver (334), the transceiver (318) of the ring (104) wirelessly communicating with the transceiver (334) of the cellular telephone (112) to thereby transmit the captured image from the ring (104) to cellular telephone (112), the imaging processing module (332) identifying the text within the captured image, the audio conversion module (333) thereafter converting the identified text into an audio file, the audio playback module (335) thereafter audibilizing the audio file so that the user can perceive the text associated with the object.

4. The system as described in claim 3 wherein the object is a piece of paper and the captured image is within the associated image constraint if the entire piece of paper is within the camera's (314) field of view.

5. The system as described in claim 3 wherein the object is a piece of paper and the captured image is within the associated image constraint if the associated text is in focus.

6. The system as described in claim 3 wherein the object is a piece of paper and the captured image is within the associated image constraint if the captured image is sufficiently clear to permit the text to be converted.

7. The system as described in claim 3 wherein the sensors (310) and the processor (304) are used to determine whether the captured image is within the associated image constraint, partially within the associated image constraint, or entirely outside the associated image constraint.

8. The system as described in claim 7 wherein the haptic feedback device (312) generates a distinct vibration depending upon whether the captured image is within the associated image constraint, partially within the associated image constraint, or entirely outside the associated image constraint.

9. The system as described in claim 8 wherein the controls (308) are used to recapture the image of the object if the captured image is partially within or entirely outside the associated image constraint.

10. The system as described in claim 3 wherein the audio playback module (315) is configured to overlay the audio file over the audio associated with a phone call.

11. The system as described in claim 3 wherein the audio playback module (315) audibilizes the audio file via a speaker.

12. The system as described in claim 3 wherein the audio playback module (315) audibilizes the audio file via a headset.

13. The system as described in claim 3 wherein the object is a sign and the captured image is within the associated image constraint if the entire sign is within the camera's (314) field of view.

14. The system as described in claim 3 wherein the object is a sign and the captured image is within the associated image constraint if the associated text is in focus.

15. The system as described in claim 3 wherein the sensors (310) are used to determine whether the camera (314) is being held level with the object.

16. The system as described in claim 3 wherein the object is a food package.

17. The system as described in claim 3 wherein the sensors (310) are used to determine the temperature of the object.
